(19) United States
(12) Patent Application Publication
(10) Pub. No.: US 2017/0208811 A1
(43) Pub. Date: Jul. 27, 2017

(54) METHOD FOR CONTROLLING PESTS

(71) Applicant: Sumitomo Chemical Company, Limited, Chuo-ku, Tokyo (JP)

(72) Inventor: Emiko SAKAMOTO, Kasai-shi, Hyogo (JP)

(21) Appl. No.: 15/327,747

(22) PCT Filed: Jul. 17, 2015
(86) PCT No.: PCT/JP2015/070521

§ 371 Date: Jan. 20, 2017

(30) Foreign Application Priority Data
Jul. 22, 2014 (JP) 2014-148534

(51) Int. Cl. A01N 51/00; A01C 14/00; A01N 25/12; A01N 43/40; A01N 43/90; A01M 1/20; A01N 43/88

(52) U.S. Cl. CPC A01N 51/00; A01M 1/20; A01C 14/00; A01N 43/88; A01N 43/40; A01N 43/90; A01N 25/12

(57) ABSTRACT

A method is provided which exhibits an excellent controlling effect on pests. The method includes a step of performing a soil incorporation treatment with a granule containing one or more compounds selected from the following compound group (A) and one or more compounds selected from the following compound group (B). Compound group (A) is a group consisting of clothianidin, thiamethoxam, imidacloprid, and fipronil, and Compound group (B) is a group consisting of fluopyram and a compound represented by the following formula (1)

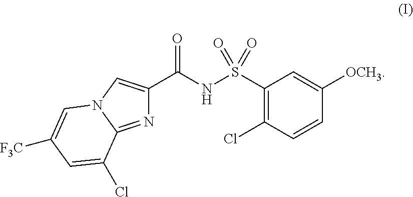 [SMILES: COc1ccc(Cl)c(S(=O)(=O)NC(=O)c2cn3cc(C(F)(F)F)cc(Cl)c3n2)c1]

### TECHNICAL FIELD

The present invention relates to a method for controlling pests.

### BACKGROUND ART

Various compounds having a controlling effect on pests that harm crops such as arthropods including insects, and nematodes, are known (refer to Patent Literatures 1, 2, and 3, and Non-Patent Literature 1). However, in the method for controlling pests using these compounds, sufficient effects could not be obtained in some cases.

### CITATION LIST

### Patent Literature

[Patent Literature 1] European Patent Application Publication No. 0580553
[Patent Literature 2] European Patent Application Publication No. 0295117
[Patent Literature 3] WO 2010/129500 Pamphlet

### Non-Patent Literature

[Non-Patent Literature 1] The Pesticide Manual-16th edition (BCPC published); ISBN 978-1-901396-86-7

### SUMMARY OF INVENTION

### Problems to be Solved by Invention

An object of the present invention is to provide a method for controlling pests, exhibiting an excellent controlling effect on pests.

### Means to Solve Problems

As a result of intensive studies to solve the above problem, the present inventor found that by performing a soil incorporation treatment with a granule containing one or more compounds selected from the following compound group (A) and one or more compounds selected from the following compound group (B), controlling effect on pests is improved.

That is, the present invention is as described in the following [1] to [5].

[1] A method for controlling pests comprising a step of performing a soil incorporation treatment with a granule containing one or more compounds selected from the following compound group (A) and one or more compounds selected from the following compound group (B):
Compound group (A): a group consisting of clothianidin, thiamethoxam, imidacloprid, and fipronil,
Compound group (B): a group consisting of fluopyram and a compound represented by the following formula (1)

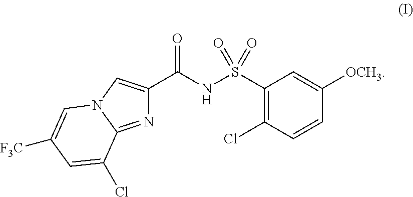 [SMILES: COc1ccc(Cl)c(S(=O)(=O)NC(=O)c2cn3cc(C(F)(F)F)cc(Cl)c3n2)c1]

[2] The method for controlling pests according to [1], wherein the weight ratio of one or more compounds selected from the compound group (A) to one or more compounds selected from the compound group (B) is within a range of 20:1 to 1:200.
[3] The method for controlling pests according to [1] or [2], wherein the step of performing a soil incorporation treatment is a step of mixing the granule with soil within a depth range to 80 cm from the soil surface.
[4] The method for controlling pests according to any one of [1] to [3], comprising a step of planting crops.
[5] The method for controlling pests according to [4], wherein the step of planting crops is a step of planting crops in a planting hole or a planting furrow within a depth range of 2 to 60 cm.
[6] The method for controlling pests according to any one of [1] to [5], in which the granule containing one or more compounds selected from the compound group (A) and one or more compounds selected from the compound group (B) is a mixture of a granule containing one or more compounds selected from the compound group (A) and a granule containing one or more compounds selected from the compound group (B).

### MODE FOR CARRYING OUT THE INVENTION

The present invention has a step of performing a soil incorporation treatment with a granule containing one or more compounds selected from the compound group (A) (hereinafter, referred to as the compound A) and one or more compounds selected from the following compound group (B) (hereinafter, referred to as the compound B).

First, the compound A and the compound B used in the present invention will be described. Clothianidin, thiamethoxam, imidacloprid, fipronil, and fluopyram are all known compounds, and these are described in 225, 1104, 640, 491, and 528 of “The Pesticide Manual-16th edition (BCPC published); ISBN 978-1-901396-86-7”.

These compounds may be obtained from commercially available formulations or produced by a known method.

In addition, the compound represented by the formula (1) (hereinafter, referred to as the compound (1)) is also a known compound, and may be produced by the method described in WO 2010/129500 pamphlet.

A granule containing the compound A and the compound B used in the present invention (hereinafter, referred to as the present granule) may be produced by a known production method. Examples of the known production method include granulation methods such as rolling granulation, spray granulation, extrusion and granulation, and impregnation methods. The total content of the compound A and the compound B in the present granule is usually within a range of 0.02% to 30% by weight, preferably within a range of 0.04% to 20% by weight, and more preferably within a range of 0.1% to 15% by weight. In addition, the present granule may be a mixture of a granule containing the compound A (hereinafter, referred to as the present granule A) and a granule containing the compound B (hereinafter, referred to as the present granule B). In this case, the content of the compound A in the present granule A and the content of the compound B in the present granule B each are usually within a range of 0.01% to 30% by weight, preferably within a range of 0.02% to 20% by weight, and more preferably within a range of 0.05% to 15% by weight.

The present invention relates to a method for controlling pests by treating soil for cultivating crops with the present granule, wherein the treatment form is soil incorporation. Examples of the soil incorporation include a pricking-in hole treatment (soil incorporation), a planting furrow treatment (soil incorporation), a planting row treatment (soil incorporation), and a broadcast treatment (soil incorporation). Here, the pricking-in hole treatment soil incorporation (sometimes, referred to as pricking-in hole soil incorporation) refers to a embodiment in which the present granule is put in a hole (planting hole) opened in the soil to plant crops, and is mixed with the soil at the bottom of the planting hole, and the planting furrow treatment soil incorporation (sometimes, referred to as planting furrow soil incorporation) refers to a embodiment in which the present granule is put in a furrow (planting furrow) formed in the soil to plant crops, and is mixed with the soil at the bottom of the planting furrow. The planting row treatment soil incorporation (sometimes, referred to as planting row soil incorporation) refers to an embodiment in which the present granule is put in a row on the surface of soil where crops are planted, and is mixed with the surface soil. In addition, the broadcast treatment soil incorporation (sometimes, referred to as broadcast soil incorporation) refers to an embodiment in which the present granule is put on the entire surface of soil where crops are planted, and is mixed with the surface soil. In the present invention, the surface soil is a soil layer in the uppermost part of soil where crops are cultivated, and means a soil layer dug up to cultivate crops. In the present invention, among the soil incorporations, the planting furrow treatment soil incorporation, the planting row treatment soil incorporation, and the broadcast treatment soil incorporation are preferable, and the broadcast treatment soil incorporation is more preferable. In addition, in the case of the planting row treatment soil incorporation and the broadcast treatment soil incorporation, an aspect in which mixing is performed such that the compound A and the compound B are present in the soil within a depth range to 80 cm from the soil surface is preferable. The depth from the soil surface is preferably within a range of 0 to 60 cm, more preferably 0 to 30 cm, and still more preferably 0 to 7 cm.

In the present invention, although the treatment amount of the present granule may vary depending on the type of crop, the type and the degree of occurrence of pests to be controlled, treatment timing, and weather conditions, the treatment amount is usually within a range of 0.1 to 5000 g, preferably within a range of 1 to 2000 g, and more preferably within a range of 10 to 1500 g per 1000 m² of the land where crops are cultivated, as the total amount of the compound A and the compound B.

In addition, a treatment is performed such that the weight ratio of the compound A to the compound B is usually within a range of 20:1 to 1:200, preferably within a range of 10:1 to 1:100, more preferably within a range of 2:1 to 1:50, and still more preferably within a range of 2:1 to 1:20.

The present invention includes an aspect having a step of planting crops, and as described above, in the present invention, a step (hereinafter, referred to as a step 1) of performing a soil incorporation treatment with the present granule is carried out, and then, a step of planting crops (hereinafter, referred to as a step 2) is carried out. In a case where the present invention has the step 2, according to the present invention, it is possible to control pests that harm crops. Examples of the crops include the following crops.

Crops: corn, rice, cotton, soybean (including green soybean), peanut, sugar beet, rapeseed, sunflower, sugar cane, tobacco, etc.

Vegetables: vegetables from family Solanaceae (eggplant, tomato, green pepper, potato, pepper, etc.), vegetables from family Cucurbitaceae (cucumber, squash, watermelon, melon, oriental melon, bitter ground fruit, winter melon, oriental pickling melon, zucchini, etc.), vegetables from family Cruciferae (horseradish, kohlrabi, chinese cabbage, cabbage, mustard, broccoli, cauliflower, rape, etc.), vegetables from family Compositae (edible chrysanthemum, lettuce, etc.), vegetables from family Liliceae (green onion, chive, onion, garlic, spring onion, shallot, asparagus, etc.), vegetables from family Apiaceae (carrot, parsley, celery, parsnip, etc.), vegetables from family Chenopodiaceae (spinach, chard, etc.), vegetables from family Lamiaceae (Japanese basil, mint, basil, etc.), strawberry, sweet potato, Japanese yam, Chinese yam, taro, konjac, gingko biloba, lotus, ginger, etc.

Fruit trees: pomaceous fruits (apples, European pears, Japanese pears, Chinese quinces, quinces, etc.), stone fruits (peaches, Japanese plums, nectarines, Chinese plums, cherries, apricots, prunes, etc.), citrus (satsuma mandarins, oranges, lemons, limes, grapefruits, etc.), nut trees (chestnut, walnut, hazelnut, almond, pistachio, cashew nut, macadamia nut, etc.), berry fruits (blueberries, cranberries, blackberries, raspberries, etc.), grapes, oysters, olives, loquats, bananas, coffee, date palms, coconuts, oil palms, etc.

Trees other than fruit trees: tea, mulberry, flowering trees (royal azalea, peony, azalea, camellia, hydrangea, sasanqua, Japanese star anise, cherry, tulip tree, crape myrtle, fragrant olive, etc.), street trees (ash, birch tree, dogwood, eucalyptus, ginkgo, lilac, maple, oak, poplar, cercis, sweetgum, sycamore, Japanese zelkova, Japanese arborvitae, fir tree, hemlock, juniper, pine, spruce, yew, elm, horse chestnut, etc.), sweet viburnum, podocarpus, cedar, Japanese cypress, croton, Japanese spindle tree, Japanese photinia, etc.

Flowers and ornamental plants: tulip, lily, iris, petunia, chrysanthemum, lisianthus, gerbera, carnation, etc.

Among the above crops, potato, sweet potato, taro, Japanese yam, cucumber, melon, pumpkin, watermelon, tomato, eggplant, green pepper, strawberry, cabbage, green onion, chive, and green soybean are preferable, and potato and sweet potato are particularly preferable.

The above crops may be crops to which herbicide tolerance, tolerance to pests or tolerance to environmental stress have been imparted by gene recombination techniques or classical breeding methods by mating.

The present invention is particularly suitable as a method for controlling pests in the case of planting and cultivating vegetative organs or seedlings of crops. Here, the vegetative organs mean shoots and roots, or a part thereof, and in the present invention, leaves and stems are collectively referred to as a shoot. Specific examples of the vegetative organs include a tuberous root, a bulb, a corm or a solid bulb, a tuber, a rhizome, a stolon, a rhizophore, propagule, and vine cutting. The stolon is sometimes called a runner, and the propagule is sometimes called a broad bud or a bulbil. In addition, the vine cutting is a shoot of sweet potato or Japanese yam. In the present invention, seedling and sapling are collectively referred to as seedlings, and refer to an infant plant whose the leaf age is usually within a range of 1 leaf stage to 15 leaf stage of a true leaf, preferably within a range of 1 leaf stage to 5 leaf stage of a true leaf, and more preferably within a range of 1.5 leaf stage to 3 leaf stage of a true leaf.

In addition, in the present invention, an embodiment in which potato tubers or sweet potato vines are planted is preferable.

The method of planting crops will be more specifically described according to each form of soil incorporation. In a case where the form of soil incorporation is the pricking-in hole treatment soil incorporation, after mixing the present granule and the soil at the bottom of the planting hole, crops are planted in the planting hole. The depth of the planting hole is usually within a range of 2 to 60 cm, preferably within a range of 2 to 40 cm, and more preferably within a range of 2 to 20 cm. In the case of the planting furrow treatment soil incorporation, after mixing the present granule and the soil at the bottom of the planting furrow, crops are planted in the planting furrow. The depth of the planting furrow is usually within a range of 2 to 60 cm, preferably within a range of 2 to 40 cm, and more preferably within a range of 2 to 20 cm. In the case of the planting row treatment soil incorporation, after mixing the present granule placed in a row and the surface soil, ridges are made as necessary, and crops are planted in planting holes or planting furrows formed in the soil. In the case of making ridges, ridges are made in advance, the present granule on the ridges is placed in a row, and soil incorporation may be performed. In the case of the broadcast treatment soil incorporation, after mixing the present granule and the surface soil, ridges are made as necessary, and crops are planted in planting holes or planting furrows formed in the soil. The depth of planting hole or planting furrows formed in the soil after the planting row treatment soil incorporation or after the broadcast treatment soil incorporation is usually within a range of 2 to 60 cm, preferably within a range of 2 to 40 cm, more preferably within a range of 2 to 20 cm, and still more preferably within a range of 2 to 5 cm.

In addition, the step 2 is preferably performed during the period from immediately after the step 1 is performed to the 20th day after the step 1 is performed, and more preferably performed during the period from immediately after the step 1 is performed to the 10th day after the step 1 is performed.

The present invention includes an aspect having a step (hereinafter, referred to as a step 3) of covering the soil surface with a covering material. As the covering material, a plastic film is preferably used. The covering materials are sometimes called a mulch or a mulching film, and specific examples thereof include a white, black, green, or transparent polyethylene mulching film, a polyethylene double layer mulching film whose the surface is silver and the back surface is black or the surface is white and the back surface is black, and a biodegradable mulching film which has a fatty acid ester, a polyvinyl alcohol, polybutyl succinate, or high molecular weight starch or pulp, as a raw material. In the present invention, a black polyethylene mulching film is preferably used. The timing to start covering with a covering material, is preferably during the period from immediately after a treatment is performed with the present granule to 20th day after the treatment, more preferably during the period from immediately after the treatment to 10th day after the treatment, and still more preferably immediately after the treatment.

In a case where the present invention has the step 2 and the step 3, as the order of performing the steps, usually, first, the step 1 is performed, and then, the step 2 and the step 3 are performed. After the step 1 is performed, first, the step 2 is performed, and then, the step 3 may be performed, or the order may be reversed. In a case where the step 3 is performed after the step 2, the step 3 is preferably performed during the period from immediately after the step 2 is performed to the 20th day after the step 2 is performed. In a case where the step 2 is performed after the step 3, the step 2 is preferably performed during the period from immediately after the step 3 is performed to the 20th day after the step 3 is performed, and more preferably performed during the period from immediately after the step 3 is performed to the 10th day after the step 3 is performed.

Hereinafter, aspects of the present invention will be shown. In the following aspects, a step 1 will be described by dividing into a step of placing the granule on the soil (hereinafter, referred to as a step 1-1) and a step of mixing the granule and the soil (hereinafter, referred to as a step 1-2).

(I) A method of performing the step 1-1 and the step 1-2 separately.
(II) A method of continuously performing the step 1-1 and the step 1-2 almost at the same time.
(III) A method of continuously performing the step 1-1, the step 1-2, and a step 2 almost at the same time.
(IV) A method of continuously performing the step 1-1, the step 1-2, and a step of making ridges almost at the same time.
(V) A method of continuously performing the step 1-1, the step 1-2, the step of making ridges, and a step 3 almost at the same time.
(VI) A method of performing the step 1-1 and the step 1-2 separately, and then, continuously performing the step of making ridges, and the step 3 almost at the same time.
(VII) A method of continuously performing the step 1-1 and the step 1-2 almost at the same time, and then, continuously performing the step of making ridges and the step 3 almost at the same time.

In a case where the step 1-1 and the step 1-2 are performed separately, the step 1-2 is performed after the step 1-1. The step 1-1 may be performed by using a chemical spraying machine such as a tractor equipped with a power spraying machine or an electric chemical treatment machine, or may be performed manually. The step 1-2 may be performed by using a machine capable of soil incorporation, such as a tiller or a tractor equipped with a rotary, or may be performed manually by using a hoe or a spade. In addition, by using a machine capable of an operation of chemical spraying and an operation of soil incorporation at the same time (an electric chemical treatment machine, a tractor equipped with a rotary, etc.), the step 1-1 and the step 1-2 may be continuously performed almost at the same time.

The method of continuously performing the step 1-1, the step 1-2, and the step 2 almost at the same time may be performed using a machine capable of an operation of pesticide spraying, an operation of soil incorporation, and an operation of transplanting at the same time (an transplanting machine equipped with an electric chemical treatment machine, etc.). The method of continuously performing the step 1-1, the step 1-2, and the step of making ridges almost at the same time may be performed using a machine capable of an operation of chemical spraying, an operation of soil incorporation, and an operation of making ridges at the same time (a tractor equipped with an electric chemical treatment machine, a hiller, etc.). In addition, the method of continuously performing the step 1-1, the step 1-2, the step of making ridges, and the step 3 almost at the same time may be performed using a machine capable of an operation of chemical spraying, an operation of soil incorporation, an operation of making ridges, and an operation of mulch-covering at the same time (a tractor equipped with an electric chemical treatment machine, a mulcher, etc.). The mulcher is a collective term for machines capable of an operation of making ridges and an operation of mulch-covering at the same time, and by using a mulcher, the step of making ridges and the step 3 may be continuously performed almost at the same time.

In the present invention, one or more other pesticides may also be used in combination. Examples of other pesticides include insecticides, nematicides, fungicides, herbicides, plant growth regulators, and safeners. Other pesticides may be treated together with the present granule at the same time, or may be separately treated.

According to the invention, it is possible to control pests (insects and nematodes). Specific examples of the pests include the following pests.

Hemiptera pests: planthoppers such as small brown planthoppers (Laodelphax striatellus), leafhoppers such as tea green leafhoppers (Empoasca onukii), aphids such as cotton aphids (Aphis gossypii), green peach aphids (Myzus persicae), cabbage aphids (Brevicoryne brassicae), spiraea aphids (Aphis spiraecola), potato aphids (Macrosiphum euphorbiae), greenhouse potato aphids (Aulacorthum solani), bird-cherry oat aphids (Rhopalosiphum padi), black citrus aphids (Toxoptera citricidus), mealy plum aphids (Hyalopterus pruni), pea aphids (Acyrthosiphon pisum), quercus aphids (Rhopalosiphum nymphaeae), Aphis naturtii, and Aphisfabae, stink bugs such as brown marmorated stink bugs (Halyomorpha mista) and turnished plant bugs (Lygus lineolaris), whiteflies such as greenhouse whiteflies (Trialeurodes vaporariorum), silverleaf whiteflies (Bemisia tabaci), silverleaf whiteflies (Bemisia argentifolii), citrus whiteflies (Dialeurodes citri), and orange spiny whiteflies (Aleurocanthus spiniferus), and scale insects such as red scales (Aonidiella aurantii) and San Jose scales (Comstockaspis perniciosa).

Lepidoptera pests: pyralids such as Asian corn borers (Ostrinia furnacalis), cabbage webworms (Hellula undalis), bluegrass webworms (Pediasia teterrellus), and European corn borers (Ostrinia nubilaris), noctuids such as oriental leafworm moths (Spodoptera litura) and black cutworms (Agrotis ipsilon), pieridae such as small white butterflies (Pieris rapae), leaf roller moths such as codling moths (Cydia pomonella), ermine moths such as diamondback moths (Plutella xylostella), and moths such as potato tuber moths (Phthorimaea operculella).

Thysanoptera pests: thrips such as western flower thrips (Frankliniella occidentalis), southern yellow thrips (Thrips parmi), yellow tea thrips (Scirtothrips dorsalis), onion thrips (Thrips tabaci), flower thrips (Frankliniella intonsa), and tobacco thrips (Frankliniella fusca).

Diptera pests: root-maggots such as bean seed flies (Delia platura) and onion flies (Delia antiqua), and leafminer flies such as vegetable leafminers, (Liriomyza sativae), American serpentine leafminers (Liriomyza trifolii), and garden pea leafminers (Chromatomyia horticola).

Elytron pests: corn rootworms (Diabrotica spp.) such as western corn rootworms (Diabrotica virgifera virgifera) and southern corn rootworms (Diabrotica undecimpunctata howardi), scarabaeid beetles such as scarab beetles (Anomala cuprea), sugarcane white grub (Anomala albopilosa), soybean beetles (Anomala rufocuprea), and Japanese beetles (Popillia japonica), weevils such as brown gourd weevil (Sphenophorus uniformis), leaf beetles such as cucurbit leaf beetles (Aulacophora femoralis) and Colorado potato beetles (Leptinotarsa decemlineata), and click beetles (Agriotes spp.).

Nematodes: nematodes of genus Meloidogyne such as southern root-knot nematodes (Meloidogyne incognita), Javanese root-knot nematodes (Meloidogyne javanica), northern root-knot nematodes (Meloidogyne hapla), Arenalia root-knot nematodes (Meloidogyne arenaria), and south sea root-knot nematodes (Meloidogyne microcephala), nematodes of genus Ditylelenchus such as potato rot nematodes (Ditylelenchus destructor) and stem nematodes (Ditylelenchus dipsaci), nematodes of genus Pratylenchus such as south meadow nematodes (Pratylenchus cffeae), north meadow nematodes (Pratylenchus penetrans), walnut meadow nematodes (Pratylenchus vulnus), wheat meadow nematodes (Pratylenchus neglectus), and tea leaf meadow nematodes (Pratylenchus loosi), nematodes of genus Globodera such as potato cyst nematodes (Globodera rostochiensis) and yellow potato cyst nematode (Globodera pallida), nematodes of genus Heterodera such as soybean cyst nematodes (Heterodera glycines) and sugar beet nematodes (Heterodera shachtoii), nematodes of genus Aphelenchoides such as black currant nematodes (Aphelenchoides ritzemabosi), nematodes of genus Radopholus such as chrysanthemum foliar nematodes (Radopholus similis) and citrus sprading decline nematodes (Radopholus citrophilus), nematodes of genus Tylenchulus such as citrus nematodes (Tylenchulus semipenetrans), nematodes of genus Rotylenchulus such as reniform nematodes (Rotylenchulus reniformis), nematodes of genus Ditylenchus such as strawberry bud nematodes (Nothotylenchus acris), nematodes of Nacobbus genus such as false root-knot nematodes (Nacobbus aberrans), and nematodes of Hemicriconemoides genus such as kanayasawa nematodes (Hemicriconemoides kanayaensis).

The present invention is suitable as a method for controlling aphids, whiteflies, pyralids, noctuids, ermine moths, thrips, leafminer flies, scarabaeid beetles, and click beetles as insects, and southern root-knot nematodes, northern root-knot nematodes, Arenalia root-knot nematodes, south meadow nematodes, north meadow nematodes, and potato cyst nematodes as nematodes, among the above-described pests, and is particularly suitable as a method for controlling aphids, ermine moths, noctuids, scarabaeid beetles, and southern root-knot nematodes.

### EXAMPLES

Hereinafter, test examples of the present invention will be described in more detail, and the present invention is not limited to the following examples.

A 2.0% granule of fluopyram (defined below) and 2.0% granule of the compound (1) (defined below) used in the following test examples were prepared by the following method, respectively.

50.5 mg of fluopyram or the compound (1) and 100 mg of acetone (manufactured by Wako Pure Chemical Industries, Ltd.) were put into a 6 ml volume glass screw tube (manufactured by Maruemu Corporation), then, the tube was capped, and the mixture was irradiated with ultrasound, whereby a mixed solution of fluopyram and acetone and a mixed solution of the compound (1) and acetone were obtained, respectively.

Next, 2.4495 g of a ceramic porous body (product name: APLS N, containing silica (CAS No. 7631-86-9), aluminum oxide (CAS No. 1344-28-1), and iron oxide (CAS No. 1309-37-1), as ingredients, manufactured by ISOLITE INSULATING PRODUCTS CO., LTD.) was put into a 6 ml volume glass screw tube (manufactured by Maruemu Corporation), 150.5 mg of the above mixed solution was added thereto two times by being divided at room temperature, the tube was capped, and the resulting product was sufficiently mixed and impregnated. Thereafter, the tube was uncapped, and the acetone was evaporated by air drying at room temperature for 6 hours, whereby 2.5 g of a granule containing 2% by weight of fluopyram (hereinafter, referred to as a 2.0% granule of fluopyram) and 2.5 g of a granule containing 2% by weight of the compound (1) (hereinafter, referred to as a 2.0% granule of the compound (1)) were obtained, respectively.

### Test Example 1

A 1.0% granule of imidacloprid (product name: ADMIRE 1 Granule, manufactured by Bayer CropScience), a 0.5% granule of thiamethoxam (product name: ACTARA granule 5, manufactured by Syngenta Japan K. K.), a 2.0% granule of fluopyram, and a 2.0% granule of the compound (1) were mixed according to the amounts shown in the following Table 1, whereby test formulations (mixed granules) 1-1 to 2-2 were obtained, respectively. Mixing was performed in a 20 ml volume glass screw tube (manufactured by Maruemu Corporation).

A 860 ml volume plastic cup (the surface area of the upper surface of the cup was about 1/10000 a) was filled with 700 g of soil, then, 150 ml of water was added thereto, and the resulting product was sufficiently mixed, whereby soil for cultivation was prepared. A granule was uniformly put on the surface of the soil for cultivation in each cup such that the treatment amount of each active ingredient per 10 a became as shown in Table 2 or 3, and sufficiently mixed with the soil for cultivation (broadcast treatment soil incorporation). The depth of the mixed soil was about 7 cm. Immediately, a furrow having a depth of about 5 cm was formed along the center line (diameter) of the soil for cultivation in the cup, then, a sweet potato vine was planted in the furrow, and the cup was placed in a room (25° C.). 7 days after planting (soil incorporation treatment of a granule), 10 second-instar larvae of Spodoptera litura were released, and the above-ground part was fully covered with a plastic cup for preventing the tested insects from escaping. This is called as a treated section A.

After performing a soil incorporation treatment with the granule in the same manner as in the treated section A, immediately, the surface of the soil for cultivation was covered with polyethylene black mulch (manufactured by SEKISUI FILM CO., LTD.), a furrow having a depth of about 5 cm was formed along the center line (diameter) of the soil for cultivation in the cup (to make formation of the furrow easy, a notch was made in the black mulch before formation of the furrow), a sweet potato vine was planted in the furrow, and the cup was placed in a room (25° C.). For other than the above-described, the same operation as in the treated section A was performed. This is called a treated section B.

A 50% granulated wettable powder of imidacloprid (product name: ADMIRE granulated wettable powder, manufactured by Bayer CropScience) and a 10% granulated water soluble powder of thiamethoxam (product name: ACTARA granulated water soluble powder, manufactured by Syngenta Japan K. K.) were mixed with water to have a predetermined concentration, respectively, whereby an imidacloprid-containing chemical solution and a thiamethoxam-containing chemical solution were obtained, respectively. A mixed solution obtained by mixing each of fluopyram and the compound (1) with acetone (manufactured by Wako Pure Chemical Industries, Ltd.) including 5% (w/v) of polyoxyethylene coconut oil fatty acid sorbitan (20 E.O.) (SORGEN TW-20, manufactured by Dai-ichi Kogyo Seiyaku Co., Ltd.) (the amount of acetone per 1 mg of an active ingredient was 0.1 ml) was mixed with water to have a predetermined concentration, respectively, whereby a fluopyram-containing chemical solution and a compound (1)-containing chemical solution were obtained, respectively. From these chemical solutions, a mixed chemical solution of imidacloprid and fluopyram and a mixed chemical solution of thiamethoxam and the compound (1) were further prepared, respectively.

A 860 ml volume plastic cup (the surface area of the upper surface of the cup was about 1/10000 a) was filled with 700 g of soil, then, 140 ml of water was added thereto, and the resulting product was sufficiently mixed, whereby the soil for cultivation was prepared. After a furrow having a depth of about 5 cm was formed along the center line (diameter) of the soil for cultivation in each cup, a sweet potato vine was planted in the furrow, then, immediately, 10 ml of the chemical solution was subjected to a drench treatment to the soil for cultivation in each cup such that the treatment amount of each active ingredient per 10 a became as shown in Table 2 or 3, and the cup was placed in a room (25° C.). The drench treatment was performed using a pipette on the soil surface so as to draw a circle having a radius of about 2 to 3 cm around the planting position of sweet potato. 7 days after planting (soil drench treatment of a chemical solution), 10 second-instar larvae of Spodoptera litura were released, and the above-ground part was fully covered with a plastic cup. This is called as a treated section C.

In addition, a 860 ml volume plastic cup (the surface area of the upper surface of the cup was about 1/10000 a) was filled with 700 g of soil, then, 10 ml of a chemical solution and 140 ml of water were added thereto such that the treatment amount of each active ingredient per 10 a became as shown in Table 2 or 3, and the resulting product was sufficiently mixed, whereby soil for cultivation was prepared. The same operation as in the treated section A was performed except that the chemical solution was subjected to a soil incorporation treatment. This is called a treated section D.

On the other hand, in the same manner as in the treated section A except for not treating with a pesticide, a sweet potato vine was planted and placed in a room, then, 7 days after planting, 10 second-instar larvae of Spodoptera litura were released, and the above-ground part was fully covered with a plastic cup. This is called a non-treated section

4 days after release, life and death of the tested insects were observed. From the observation result, the mortality was calculated according to the equation 1), and the corrected mortality was calculated according to the equation 2). The corrected mortalities are shown in Tables 2 and 3. For each treatment, there were 2 replicates.

Mortality (%)=((the number of tested insects−the number of surviving insects)/the number of tested insects)×100 Equation 1);

Corrected mortality (%)={(mortality in treated section A, B, C, or D−mortality of a non-treated section)/(100−mortality of a non-treated section)}×100 Equation 2);

In addition, description of 10 a in each table below means 10 ares.

TABLE 1

| | 1.0% | 0.5% | 2.0% | 2.0% |
|---|---|---|---|---|
| | granule of | granule of | granule of | granule of |
| | imidacloprid | thiamethoxam | fluopyram | compound (1) |
| Test | 120 mg | | 30 mg | |
| formulation | | | | |
| 1-1 | | | | |
| Test | 120 mg | | 600 mg | |
| formulation | | | | |
| 1-2 | | | | |
| Test | | 120 mg | | 15 mg |
| formulation | | | | |
| 2-1 | | | | |
| Test | | 120 mg | | 600 mg |
| formulation | | | | |
| 2-2 | | | | |

TABLE 2

| | | Treatment amount as | Corrected |
|---|---|---|---|
| Treated | Tested compound or | active ingredient | mortality |
| section | Tested chemical solution | [/10 a] | [%] |
| A | 1.0% granule of | Imidacloprid 120 g | 22 |
| | imidacloprid | | |
| | 2.0% granule of fluopyram | Fluopyram 60 g | 0 |
| | 2.0% granule of fluopyram | Fluopyram 1200 g | 0 |
| | Test formulation 1-1 | Imidacloprid 120 g | 72 |
| | | Fluopyram 60 g | |
| | Test formulation 1-2 | Imidacloprid 120 g | 78 |
| | | Fluopyram 1200 g | |
| B | Test formulation 1-1 | Imidacloprid 120 g | 78 |
| | | Fluopyram 60 g | |
| | Test formulation 1-2 | Imidacloprid 120 g | 78 |
| | | Fluopyram 1200 g | |
| C | Imidacloprid-containing | Imidacloprid 120 g | 11 |
| | chemical solution | | |
| | Fluopyram-containing | Fluopyram 60 g | 0 |
| | chemical solution | | |
| | Fluopyram-containing | Fluopyram 1200 g | 0 |
| | chemical solution | | |
| | Mixed chemical solution of | Imidacloprid 120 g | 6 |
| | imidacloprid and fluopyram | Fluopyram 60 g | |
| | Mixed chemical solution of | Imidacloprid 120 g | 11 |
| | imidacloprid and fluopyram | Fluopyram 1200 g | |
| D | Imidacloprid-containing | Imidacloprid 120 g | 6 |
| | chemical solution | | |
| | Fluopyram-containing | Fluopyram 60 g | 0 |
| | chemical solution | Fluopyram 1200 g | |
| | Fluopyram-containing | | |
| | chemical solution | | |
| | Mixed chemical solution of | Imidacloprid 120 g | 6 |
| | imidacloprid and fluopyram | Fluopyram 60 g | |
| | Mixed chemical solution of | Imidacloprid 120 g | 0 |
| | imidacloprid and fluopyram | Fluopyram 1200 g | |

TABLE 3

| | | Treatment amount as | Corrected |
|---|---|---|---|
| Treated | Tested compound or | active ingredient | mortality |
| section | Tested chemical solution | [/10 a] | [%] |
| A | 0.5% granule of | Thiamethoxam 60 g | 39 |
| | thiamethoxam | | |
| | 2.0% granule of compound | Compound (1) 30 g | 0 |
| | (1) | | |
| | 2.0% granule of compound | Compound (1) 1200 g | 0 |
| | (1) | | |
| | Test formulation 2-1 | Thiamethoxam 60 g | 95 |
| | | Compound (1) 30 g | |
| | Test formulation 2-2 | Thiamethoxam 60 g | 100 |
| | | Compound (1) 1200 g | |
| B | Test formulation 2-1 | Thiamethoxam 60 g | 100 |
| | | Compound (1) 30 g | |
| | Test formulation 2-2 | Thiamethoxam 60 g | 100 |
| | | Compound (1) 1200 g | |
| C | Thiamethoxam-containing | Thiamethoxam 60 g | 28 |
| | chemical solution | | |
| | Compound (1)-containing | Compound (1) 30 g | 0 |
| | chemical solution | | |
| | Compound (1)-containing | Compound (1) 1200 g | 0 |
| | chemical solution | | |
| | Mixed chemical solution of | Thiamethoxam 60 g | 22 |
| | thiamethoxam and | Compound (1) 30 g | |
| | compound (1) | | |
| | Mixed chemical solution of | Thiamethoxam 60 g | 28 |
| | thiamethoxam and | Compound (1) 1200 g | |
| | compound (1) | | |
| D | Thiamethoxam-containing | Thiamethoxam 60 g | 17 |
| | chemical solution | | |
| | Compound (1)-containing | Compound (1) 30 g | 0 |
| | chemical solution | | |
| | Compound (1)-containing | Compound (1) 1200 g | 0 |
| | chemical solution | | |
| | Mixed chemical solution of | Thiamethoxam 60 g | 17 |
| | thiamethoxam and | Compound (1) 30 g | |
| | compound (1) | | |
| | Mixed chemical solution of | Thiamethoxam 60 g | 11 |
| | thiamethoxam and | Compound (1) 1200 g | |
| | compound (1) | | |

### Test Example 2

A 0.5% granule of clothianidin (product name: DANTOTSU Granule, manufactured by Sumitomo Chemical Co., Ltd.), a 1.0% granule of imidacloprid (product name: ADMIRE 1 Granule, manufactured by Bayer CropScience), and a 2.0% granule of the compound (1) were mixed according to the amounts shown in the following Table 4, whereby test formulations (mixed granules) 3-1 to 4-2 were obtained, respectively. Mixing was performed in a 20 ml volume glass screw tube (manufactured by Maruemu Corporation).

A 860 ml volume plastic cup (the surface area of the upper surface of the cup was about 1/10000 a) was filled with 700 g of soil, then, 150 ml of water was added thereto, and the resulting product was sufficiently mixed, whereby soil for cultivation was prepared. A granule was uniformly put on the surface of the soil for cultivation in each cup such that the treatment amount of each active ingredient per 10 a became as shown in Table 5, and sufficiently mixed with the soil for cultivation (broadcast treatment soil incorporation). The depth of the mixed soil was about 7 cm. Immediately, a furrow having a depth of about 5 cm was formed along the center line (diameter) of the soil for cultivation in the cup, then, a sweet potato vine was planted in the furrow, and the cup was placed in a room (25° C.). 9 days after planting (soil incorporation treatment of a granule), 10 first-instar larvae of Spodoptera litura were released, and the above-ground part was fully covered with a plastic cup for preventing the tested insects from escaping. This is called a treated section.

On the other hand, in the same manner as in the treated section except for not treating with a pesticide, a sweet potato vine was planted and placed in a room, then, 9 days after planting, 10 first-instar larvae of Spodoptera litura were released, and the above-ground part was fully covered with a plastic cup. This is called a non-treated section.

5 days after release, life and death of the tested insects were observed. From the observation result, the mortality was calculated according to the above-equation 1), and the corrected mortality was calculated according to the equation 3). The corrected mortality is shown in Table 5. For each treatment, there were 2 replicates.

Corrected mortality (%)=((mortality of a treated section−mortality of a non-treated section)/(100−mortality of a non-treated section))×100 Equation 3);

TABLE 4

| | 0.5% | 1.0% | 2.0% | |
|---|---|---|---|---|
| | granule of | granule of | granule of | |
| | clothianidin | imidacloprid | compound (1) | |
| Test | 120 mg | | 15 | mg |
| formulation | | | | |
| 3-1 | | | | |
| Test | 120 mg | | 600 | mg |
| formulation | | | | |
| 3-2 | | | | |
| Test | | 120 mg | 30 | mg |
| formulation | | | | |
| 4-1 | | | | |
| Test | | 120 mg | 600 | mg |
| formulation | | | | |
| 4-2 | | | | |

TABLE 5

| | Treatment amount as | Corrected |
|---|---|---|
| Tested | active ingredient | mortality |
| compound | [/10 a] | [%] |
| Test | Clothianidin 60 g | 100 |
| formulation | Compound (1) 30 g | |
| 3-1 | | |
| Test | Clothianidin 60 g | 100 |
| formulation | Compound (1) 1200 g | |
| 3-2 | | |
| Test | Imidacloprid 120 g | 100 |
| formulation | Compound (1) 60 g | |
| 4-1 | | |
| Test | Imidacloprid 120 g | 100 |
| formulation | Compound (1) 1200 g | |
| 4-2 | | |

### Test Example 3

A 860 ml volume plastic cup (the surface area of the upper surface of the cup was about 1/10000 a) was filled with 700 g of soil, then, 150 ml of water was added thereto, and the resulting product was sufficiently mixed, whereby soil for cultivation was prepared. A granule (test formulations described in Tables 1 and 4) was uniformly put on the surface of the soil for cultivation in each cup such that the treatment amount of each active ingredient per 10 a became as shown in Table 6, and sufficiently mixed with the soil for cultivation (broadcast treatment soil incorporation). The depth of the mixed soil was about 7 cm. 10 days after the soil incorporation treatment of the granule, a furrow having a depth of about 5 cm was formed along the center line (diameter) of the soil for cultivation in the cup, then, a sweet potato vine was planted in the furrow, and the cup was placed in a room (25° C.). 5 days after planting, 10 first-instar larvae of Spodoptera litura were released, and the above-ground part was fully covered with a plastic cup for preventing the tested insects from escaping. This is called a treated section.

On the other hand, in the same manner as in the treated section except for not treating with a pesticide, a sweet potato vine was planted and placed in a room, then, 5 days after planting, 10 first-instar larvae of Spodoptera litura were released, and the above-ground part was fully covered with a plastic cup. This is called a non-treated section.

5 days after release, life and death of the tested insects were observed. From the observation result, the mortality was calculated according to the equation 1), and the corrected mortality was calculated according to the equation 3). The corrected mortality is shown in Table 6. For each treatment, there were 2 replicates.

TABLE 6

| | Treatment amount as | Corrected |
|---|---|---|
| Tested | active ingredient | mortality |
| compound | [/10 a] | [%] |
| Test | Imidacloprid 120 g | 100 |
| formulation | Fluopyram 60 g | |
| 1-1 | | |
| Test | Imidacloprid 120 g | 100 |
| formulation | Fluopyram 1200 g | |
| 1-2 | | |
| Test | Thiamethoxam 60 g | 100 |
| formulation | Compound (1) 30 g | |
| 2-1 | | |
| Test | Thiamethoxam 60 g | 100 |
| formulation | Compound (1) 1200 g | |
| 2-2 | | |
| Test | Clothianidin 60 g | 100 |
| formulation | Compound (1) 30 g | |
| 3-1 | | |
| Test | Clothianidin 60 g | 100 |
| formulation | Compound (1) 1200 g | |
| 3-2 | | |
| Test | Imidacloprid 120 g | 100 |
| formulation | Compound (1) 60 g | |
| 4-1 | | |
| Test | Imidacloprid 120 g | 100 |
| formulation | Compound (1) 1200 g | |
| 4-2 | | |

### Test Example 4

A 1.0% granule of imidacloprid (product name: ADMIRE 1 Granule, manufactured by Bayer CropScience), a 2.0% granule of the compound (1), and a 2.0% granule of fluopyram were mixed according to the amounts shown in the following Table 7, whereby test formulations (mixed granules) 5-1 to 6-2 were obtained, respectively. Mixing was performed in a 20 ml volume glass screw tube (manufactured by Maruemu Corporation).

A 860 ml volume plastic cup (the surface area of the upper surface of the cup was about 1/10000 a) was filled with 700 g of soil, then, 150 ml of water was added thereto, and the resulting product was sufficiently mixed, whereby soil for cultivation was prepared. A granule (test formulations described in Tables 1, 4, and 7) was uniformly put on the surface of the soil for cultivation in each cup such that the treatment amount of each active ingredient per 10 a became as shown in Table 8, and sufficiently mixed with the soil for cultivation (broadcast treatment soil incorporation). The depth of the mixed soil was about 7 cm. Immediately, a hole having a depth of about 5 cm and a diameter of about 4 cm were formed at the center portion of the soil for cultivation in the cup, then, a potato tuber was planted in the hole, and the cup was placed in a room (25° C.). 15 days after planting (soil incorporation treatment of a granule), about 20 second and third-instar larvae of Aphis gossypii were released, the above-ground part was fully covered with a plastic cup for preventing the tested insects from escaping. This is called a treated section.

On the other hand, in the same manner as in the treated section except for not treating with a pesticide, a potato tuber was planted and placed in a room, then, 15 days after planting, about 20 second and third-instar larvae of Aphis gossypii were released, and the above-ground part was fully covered with a plastic cup. This is called a non-treated section.

5 days after release, life and death of the tested insects were observed. From the observation results, the control value was calculated according to Equation 4). The control values are shown in Table 8. For each treatment, there were 2 replicates.

Control value (%)=100×(1−the number of surviving insects in a treated section at the time of observation/the number of surviving insects in a non-treated section at the time of observation) Equation 4);

TABLE 7

| | 1.0% | 2.0% | 2.0% |
|---|---|---|---|
| | granule of | granule of | granule of |
| | imidacloprid | fluopyram | compound (1) |
| Test | 80 mg | 20 mg | |
| formulation | | | |
| 5-1 | | | |
| Test | 80 mg | 600 mg | |
| formulation | | | |
| 5-2 | | | |
| Test | 80 mg | | 20 mg |
| formulation | | | |
| 6-1 | | | |
| Test | 80 mg | | 600 mg |
| formulation | | | |
| 6-2 | | | |

TABLE 8

| | Treatment amount as | Control |
|---|---|---|
| | active ingredient | value |
| Tested compound | [/10 a] | [%] |
| Test | Thiamethoxam 60 g | 100 |
| formulation | Compound (1) 30 g | |
| 2-1 | | |
| Test | Thiamethoxam 60 g | 100 |
| formulation | Compound (1) 1200 g | |
| 2-2 | | |
| Test | Clothianidin 60 g | 100 |
| formulation | Compound (1) 30 g | |
| 3-1 | | |
| Test | Clothianidin 60 g | 100 |
| formulation | Compound (1) 1200 g | |
| 3-2 | | |
| Test | Imidacloprid 80 g | 100 |
| formulation | Fluopyram 40 g | |
| 5-1 | | |
| Test | Imidacloprid 80 g | 100 |
| formulation | Fluopyram 1200 g | |
| 5-2 | | |
| Test | Imidacloprid 80 g | 100 |
| formulation | Compound (1) 40 g | |
| 6-1 | | |
| Test | Imidacloprid 80 g | 100 |
| formulation | Compound (1) 1200 g | |
| 6-2 | | |

1. A method for controlling pests, comprising a step of performing a soil incorporation treatment with a granule containing at least one compound selected from
group (A) consisting of clothianidin, thiamethoxam, imidacloprid, and fipronil,
and at least one compound selected from group (B) consisting of fluopyram and a compound represented by the following formula (1)

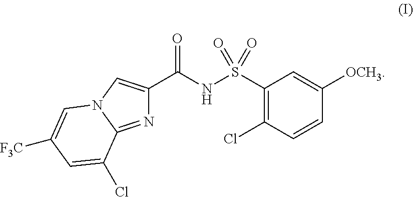 [SMILES: COc1ccc(Cl)c(S(=O)(=O)NC(=O)c2cn3cc(C(F)(F)F)cc(Cl)c3n2)c1]

2. The method for controlling pests according to claim 1, wherein a weight ratio of the at least one compound selected from group (A) to the at least one compound selected from group (B) is within a range of 20:1 to 1:200.

3. The method for controlling pests according to claim 1, wherein the step of performing a soil incorporation treatment is a step of mixing the granule with soil within a depth range down to 80 cm from a soil surface.

4. The method for controlling pests according to claim 1, further comprising a step of planting crops.

5. The method for controlling pests according to claim 4, wherein the step of planting crops is a step of planting crops in a planting hole or a planting furrow within a depth range of 2 to 60 cm from a soil surface.
